(19) United States
(12) Patent Application Publication
(10) Pub. No.: US 2018/0264976 A1
(43) Pub. Date: Sep. 20, 2018

(54) SEAT BACK WITH POWER SHOULDER PIVOT

(71) Applicant: Adient Luxembourg Holding S.à r.l., Luxembourg (LU)

(72) Inventors: Thomas David NOVITSKY, Northville, MI (US); Motohiko OZAWA, Yokohama City (JP)

(21) Appl. No.: 15/762,184

(22) PCT Filed: Oct. 11, 2016
(86) PCT No.: PCT/US16/56400

§ 371 Date: Mar. 22, 2018

Related U.S. Application Data
(60) Provisional application No. 62/258,772, filed on Nov. 23, 2015.

(51) Int. Cl. B60N 2/22; B60N 2/02; B60N 2/80; F16H 19/00

(52) U.S. Cl. CPC B60N 2/2222; B60N 2/0232; F16H 2019/008; F16H 19/001; B60N 2002/024; B60N 2/80

(57) ABSTRACT

A vehicle seat back includes a lower seat back portion and including side frame members and an upper seat back portion including side frame members including a gear sector including a lower edge with sector gear teeth. Pivot connections pivotally connect the lower side frame members to the upper side frame members. A pinion gear with gear teeth is engaged with the sector gear teeth. A motor assembly is mounted to one or both of the lower side frame members and includes a motor and an output shaft driving the pinion gear in each of two rotational directions. The rotation of the motor in one direction, pivots the upper seat back relative to the lower seat back in a forward pivot direction and rotation of the motors in an opposite direction pivots the seat back relative to the lower seat back in a rearward direction.

### CROSS REFERENCE TO RELATED APPLICATIONS

This application is a United States National Phase Application of International Application PCT/US2016/056400 filed Oct. 11, 2016, and claims the benefit of priority of U.S. provisional application 62/258,772 filed Nov. 23, 2015, the entire contents of which are incorporated herein by reference.

### FIELD OF THE INVENTION

The present invention relates to vehicle seats in general and more particularly to a vehicle seat back (backrest) with a power shoulder pivot.

### BACKGROUND OF THE INVENTION

Vehicle seats may have a seat back with a seat back frame with an upper seat back portion articulated to a lower seat back portion. The upper seat back portion is connected to the lower seat back portion at a pivot region. This allows a pivoting of the upper seat back portion relative to the lower seat back portion, changing the support of a shoulder area of the seat occupant. This provides a seat back with a shoulder pivot. The shoulder pivot allows the upper seat back portion to be pivoted relative to the lower seat back portion, allowing a range of adjustment of the angle of the upper seat back portion relative to the lower seat back portion.

U.S. Pat. No. 9,340,127 discloses a vehicle seat with a seat part and a backrest, wherein an angle formed between the seat part and the backrest can be set—a reclining backrest feature. The backrest consists of a backrest base facing the seat part and of a backrest upper part adjoining the backrest base. The backrest upper part can be pivoted with respect to the backrest base about a substantially horizontally aligned pivot axis. The angular position of the backrest upper part with respect to the backrest base can be set with respect to the seat part independently of the angular position of the backrest base . For this a first locking device is provided to fix the tilt of the backrest base with respect to the seat part in at least two positions. An operating lever operates the first locking device mechanically. A second locking device fixes the tilt of the backrest upper part with respect to the backrest base in at least two positions. A switch operates the second locking device. The switch is in active connection with a pneumatic control element and at least one pneumatic actuator element. The switch is integrated in the operating lever 6. The pneumatic actuator of the switch is bulky and adds considerable weight. The setting of the angular position of the backrest upper part with respect to the backrest base is difficult.

WO 2008/092556 A1 discloses a vehicle seat with a backrest frame that cooperates with an additional frame, that is connected to the backrest by way of a pivot axis. The pivot axis 8 is realized by means of two bearings—one each in each of the two side plates. The additional frame is constructed essentially in the shape of a U, where the free ends of the “U” are connected to the pivot axis 8. The additional frame is arranged such that it extends from the pivot axis to the top. The pivot axis is constructed so as to be in essence horizontal so that the additional frame can be pivoted, like the known tilt adjustable upper backrest sections, in an ergonomic manner totally in the region of the shoulder blade. The pivot motion of the additional frame in relation to the backrest frame is achieved by way of a motor, which is mounted inside the backrest. The motor is connected to the two hinges of the pivot axis by a transfer axle and drives both sides—the free ends of the “U” of the additional frame. The arrangement allows for an adjustment of all possible motions of the backrest—for example, pivoting the entire backrest at its hinge between it and the seat member or also adjusting the seat cushion depth or the seat cushion height, etc. The motor allows the additional frame to be moved between extreme positions with a powered adjustment. However, the arrangement with the motor is bulky and heavy. The motor size and arrangement contribute to the overall size of the vehicle seat.

### SUMMARY OF THE INVENTION

It is an object of the invention to provide a vehicle seat back with shoulder pivot for adjustment of an upper seat back portion relative to a lower seat back portion with a power drive which has components with small dimensions relative to the seat back.

Is a further object of the invention to provide a power shoulder pivot arrangement in which the seat back power package moves along with the seat back but which is light and does not substantially increase the overall dimensions of the vehicle seat.

Another object of the invention is to provide a power shoulder pivot in which the seat head restraints moves with the pivoting seat back, as opposed to remaining in a fixed position relative to the pivoting seat back.

According to the invention, a vehicle seat back is provided comprising a lower seat back portion comprising lower seat back portion frame and an upper seat back portion comprising an upper frame. The lower and upper frames are pivotably connected to each other. The lower frame may include a lower inboard side frame member defining a pivot support at an upper region and a lower outboard side frame member defining a pivot support at an upper region. The upper frame of the upper seat back portion may comprise an upper inboard side frame member with a pivot support with an associated inboard gear sector comprising a lower edge with inboard sector gear teeth and a lower outboard side frame member with a pivot support and with an associated gear sector comprising a lower edge with outboard sector gear teeth. An inboard pivot connection pivotally connects the lower inboard side frame member to the upper inboard side frame member at the pivot supports. An outboard pivot connection pivotally connects the lower outboard side frame member to the upper outboard side frame member at the pivot supports. An inboard pinion gear has gear teeth engaged with the inboard sector gear teeth. The inboard pinion gear is connected to the lower inboard side frame member for rotation in each of two rotational directions. An outboard pinion gear has gear teeth engaged with the outboard sector gear teeth. The outboard pinion gear is connected to the lower outboard side frame member for rotation in each of two rotational directions. An inboard motor assembly is mounted to the lower inboard side frame member and comprises a motor and an output shaft is connected to the inboard pinion gear for driving the inboard pinion gear in each of the two rotational directions. An outboard motor assembly is mounted to the lower outboard side frame member and comprises a motor and an output shaft connected to the outboard pinion gear for driving the outboard pinion gear in each of the two rotational directions. Operation of the motors in one direction, pivots the upper seat back relative to the lower seat back in a forward pivot direction and operation of the motors in another direction pivots the seat back relative to the lower seat back in a rearward direction.

The vehicle seat, in particular the seat back with shoulder pivot is particularly advantageous based on the provision of motor assemblies at each side of the backrest. In particular, the provision of a motor assembly, carried by the inboard side frame member and the provision of a motor assembly carried by the outboard side frame member provides the necessary power for power adjustment of the upper seat back portion relative to the lower seat back portion. Further, by positioning each motor to be carried by the side frame, a compact configuration is provided. The plural motors provide sufficient power for adjustment without taking up significant space. Further, the arrangement of a pinion gear, driven by the motor, particularly at the lower frame portion is advantageous. This particularly cooperates with the gear sector part which may be advantageously formed with the upper frame. This provides a simple and compact power train for adjustment of the seat back upper frame angular position relative to the seat back lower frame.

A head restraint may be connected to the upper seat back portion for movement with the upper seat back portion. The invention is particularly advantageous as the laterally arranged power drives of the shoulder pivot arrangement does not interfere with the mounting of the headrest on the seat back.

Each of the lower side frame members may have edge flanges or forward and rearward ends defining a motor assembly mounting region. The motor assembly mounting region has a dimension between lower side frame members of about 35 mm. The motor assembly has a width dimension of 35 mm or less and is positioned between the edge flanges of the lower side frame members. The provision of small footprint motors in combination with side members of somewhat typical allows for a compact shoulder pivot drive arrangement.

Each of the lower side frame members forward and rearward ends may define a drive arrangement operation area. The gear sector is dimensioned and the gear teeth of the gear sector and pinion gears are provided such that the gear sector moves in a pivoting range between the frame members forward and rearward ends. A relatively large adjustment angle of the seat back upper frame angular position relative to the seat back lower frame angular position is provided.

Each gear sector has a slot defining a forward and a rearward stop. Each lower side frame member has a slot follower pin that passes through the slot and allows rotation of the respective gear sector corresponding to a movement of the slot relative to the slot follower pin between the forward and the rearward stop. The positive connection between the seat back upper frame and the seat back lower frame, with slots and stops allows for a robust and dependable connection between the seat back upper frame and the seat back lower frame, with limited relative movement.

A power and control unit may be provided for powering each motor and controlling the rotational speed in rotational direction of each motor. This may be part of a seat adjustment control for longitudinal (direction of travel) movement and other aspects of seat position adjustment.

According to another aspect of the invention, a vehicle seat is provided comprising a seat base and a vehicle seat back connected to the seat base. The vehicle seat back is a seat back according to the invention.

According to another aspect of the invention a method is provided for forming a vehicle seat back according to the invention.

It is apparent that the above-described features, which will also be explained below, can be used not only in the particular combination described, but also in other combinations or alone, without going beyond the scope of the present invention.

Preferred exemplary embodiments of the present invention are shown in the drawings and will be explained in more detail in the following description, where identical reference numbers designate identical or similar or functionally identical components. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a side view of a seat back according to the invention, showing an upper seat back portion and a lower seat back portion with the upper seat back portion also shown in a full forward position in dashed line;

FIG. 2 is a sectional broken away view taken along line II-II of FIG. 3, showing the upper seat back portion and a portion of the lower seat back portion with the upper seat back portion also shown in a partially forward position in dashed line;

FIG. 3 is a front view of the seat back of FIG. 1, showing the upper seat back portion and the lower seat back portion;

FIG. 4 is a perspective view of an upper portion of the seat back and a portion of the lower seat back portion of FIG. 1, also showing the head restraint connected to and moving with the seat back upper portion;

FIG. 5 is a detail view in a region of the shoulder pin pivot at one side of the vehicle seat, between the seat back upper portion and seat back lower portion;

FIG. 6 is a detail view of the shoulder pin pivot at one side of the vehicle seat, similar to FIG. 5, with the motor assembly removed;

FIG. 7 is a perspective view of a first side gear sector, to be connected to one upper side frame member;

FIG. 8 is a perspective view of a second side gear sector, to be connected to another upper side frame member;

FIG. 9 is a perspective view showing the gear sector relative to the lower frame member with the pinion gear removed and the motor assembly removed;

FIG. 10 is a perspective view showing the gear sector relative to the lower frame member with the pinion gear removed and the motor assembly removed and showing the features of FIG. 9 from an opposite side as compared to FIG. 9, with the otherwise covered gear sector being shown in dashed line;

FIG. 11 is a perspective view of the motor assembly;

FIG. 12 is another perspective view of the motor assembly; and

FIG. 13 is a side view of a vehicle seat according to the invention showing foam/trim schematically relative to the vehicle seat frame structure.

### DESCRIPTION OF THE PREFERRED EMBODIMENTS

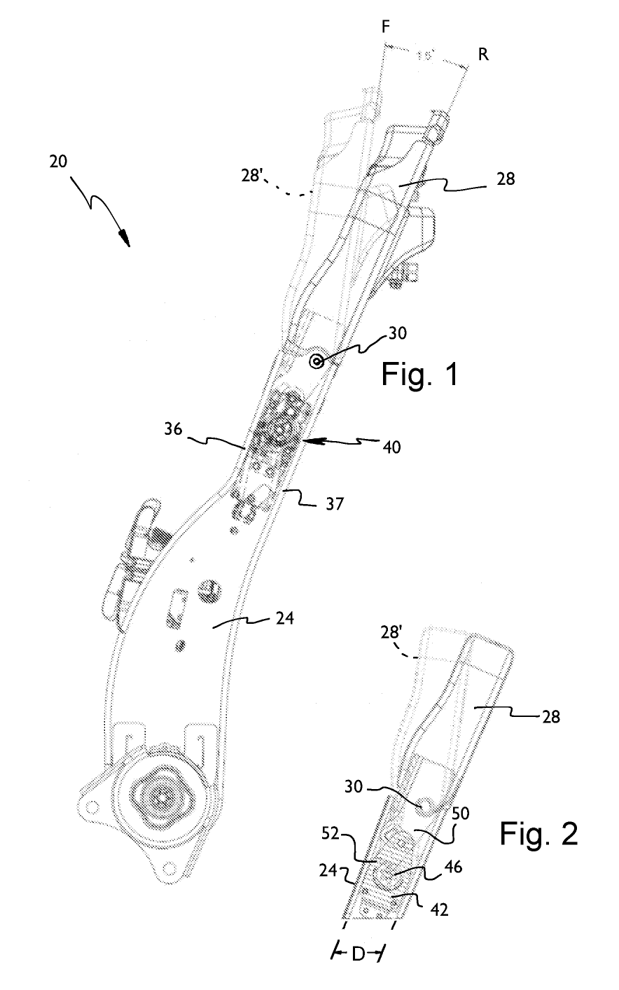

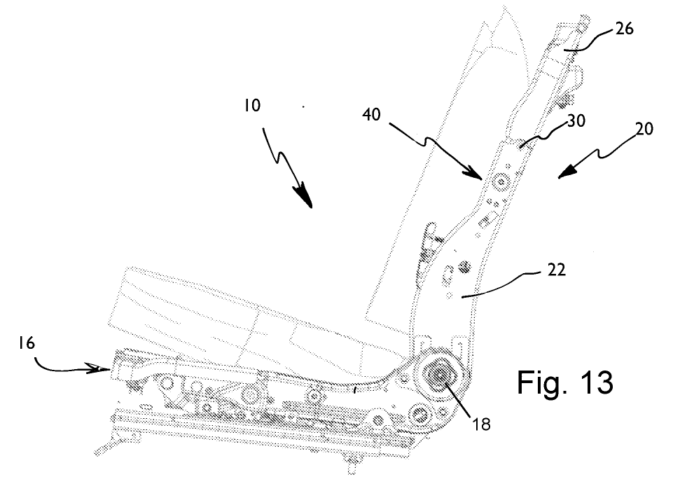

Referring to the drawings, FIG. 1 shows a side view of a backrest or seat back 20 of a vehicle seat 10 (FIG. 13). The vehicle seat 10 shown is a drivers seat, but the seat 10 may be a front passenger seat or even a rear seat.

The vehicle seat 10 comprises a seat base (also known as a cushion) 16 and a seat back 20. As shown in FIG. 13, the seat back 20 is comprised of a lower seat back portion 22 and an upper seat back portion 26. The seat back 20 is pivotably connected to the seat base 16 via a seat pivot fitting 18. The upper seat back portion 26 is pivotably connected to the lower seat back portion 22 at pivot connection 30.

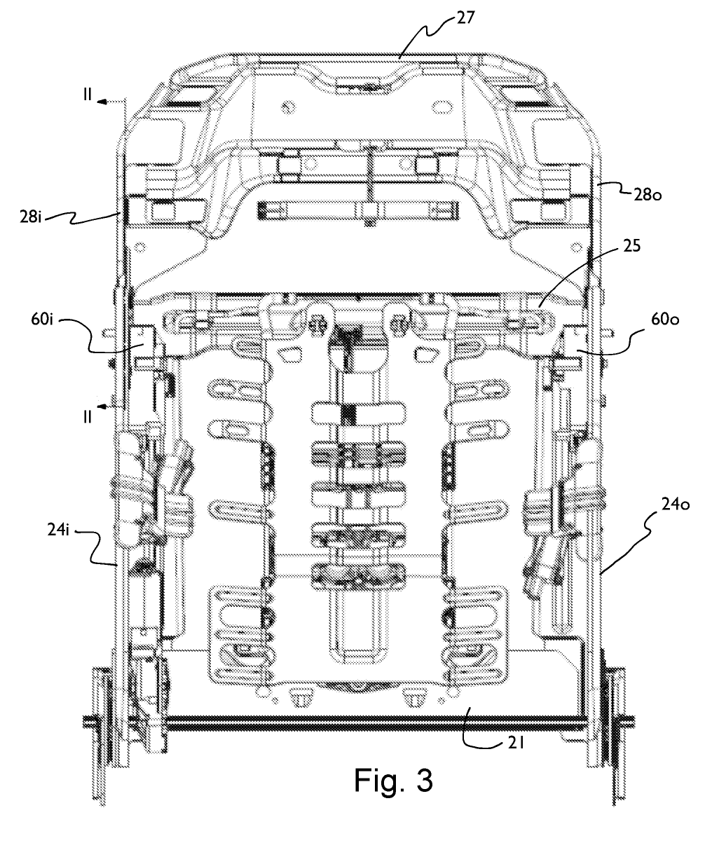

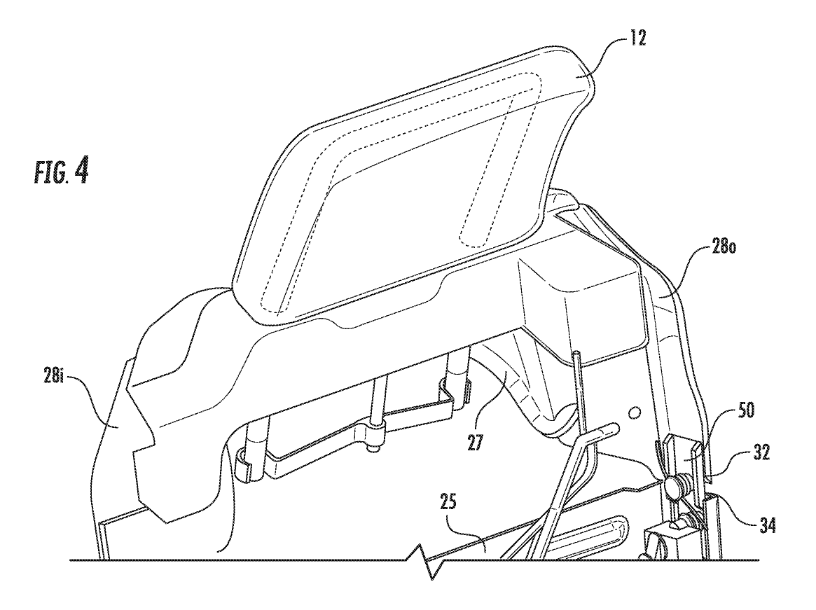

The lower seat back portion 22 is comprised of an inboard lower side frame member 24i and an outboard lower side frame member 24o as well as lower cross member 21 and middle cross member 25 (FIG. 3). The seat back 20 may incorporate a head restraint 12 connected to the upper seat back portion 26, for movement therewith (FIG. 4).

The upper seat back portion 26 is comprised of an inboard upper side frame member 28i and an outboard upper side frame member 28o and an upper cross member 27. Each of the inboard and outboard sides has pivot brackets (lower region pivot supports 34) with a pivot connection 30 between the lower seat back portion 22 and the upper seat back portion 26. Each pivot connection 30 is comprised of an upper region pivot support 32 and a lower region pivot support 34.

Each of the inboard and outboard sides has an associated power shoulder pivot drive arrangement 40, with respective motor arrangements 60i and 60o. As the configuration of the inboard side and the outboard side of the vehicle seat back 20 is essentially the same (the configurations are essentially mirror images), in the following description the structure is described which is applicable to both the inboard and outboard sides and the designation “I” and “o”—relating to inboard and outboard sides—is omitted. Only FIGS. 3 and 4 use the designations “I” and “o” to indicate the inboard and outboard sides.

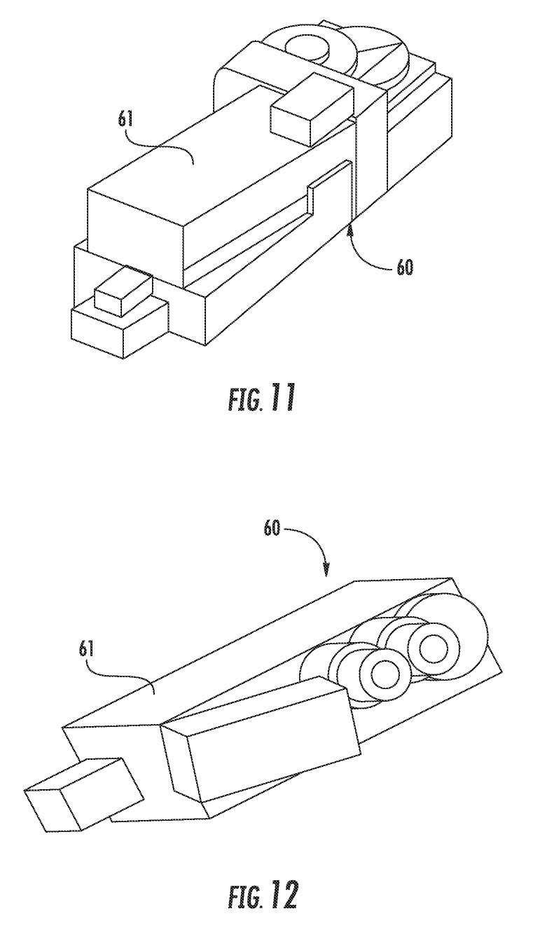

FIG. 2 shows the pivot connection 30. In the embodiment shown, a gear sector 50 is provided which is welded or otherwise fixed to the upper side frame member 28. The gear sector 50 has a lower edge with sector gear teeth 52. In the alternative, the upper side frame member 28 may itself have a lower edge with sector gear teeth 52. In the embodiment shown, the gear sector 50 includes a bearing opening providing, in cooperation with the upper side frame member 28, the upper region bearing support 32. The lower region pivot support 34 is formed as a bearing opening in a bearing bracket or bearing portion of the lower side frame member 24 (FIG. 10).

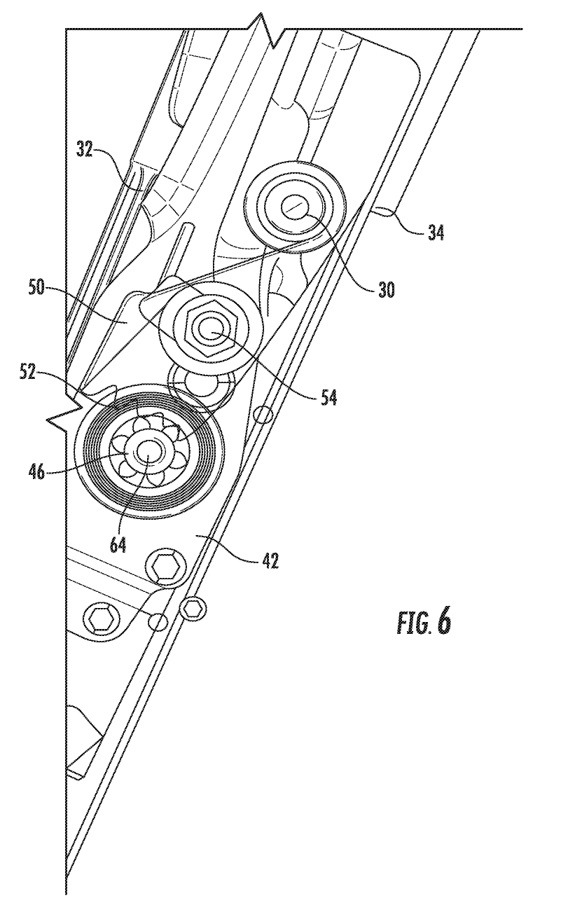

Each power shoulder pivot drive arrangement 40 is comprised of an arrangement with which the sector 50 is in a drive connection with a pinion gear 46. The rack gear teeth 52, of the gear sector 50, mesh with pinion gear teeth 48 of a pinion gear 46. The drive arrangement 40 includes a motor assembly 60 to drive the pinion gear 46, to drive gear teeth 52, to pivot the upper seat back portion 26, about the pivot 30. The drive arrangement 40 includes a support spacer bracket 42 that has a central opening (FIG. 6). The pinion gear 46 is mounted on a drive shaft 64 of the motor assembly 60, which forms a pivot bearing. The support and spacer bracket 42 and/or the lower side frame member 24 provides another pinion gear bearing 44. The drive shaft 64 is supported by pinion gear bearing 44 (FIG. 10). The pinion gear 46 has a plurality of pinion gear teeth 48. The gear sector 50 as a plurality of sector gear teeth 52 that engage the pinion gear teeth 48. Each motor assembly 60 includes a motor 62 and may include gears (transmission) to provide a gear ratio needed for driving the drive shaft 64. Each of the motors assemblies 60 are mounted to one of the brackets 42 with the drive shaft supported as noted.

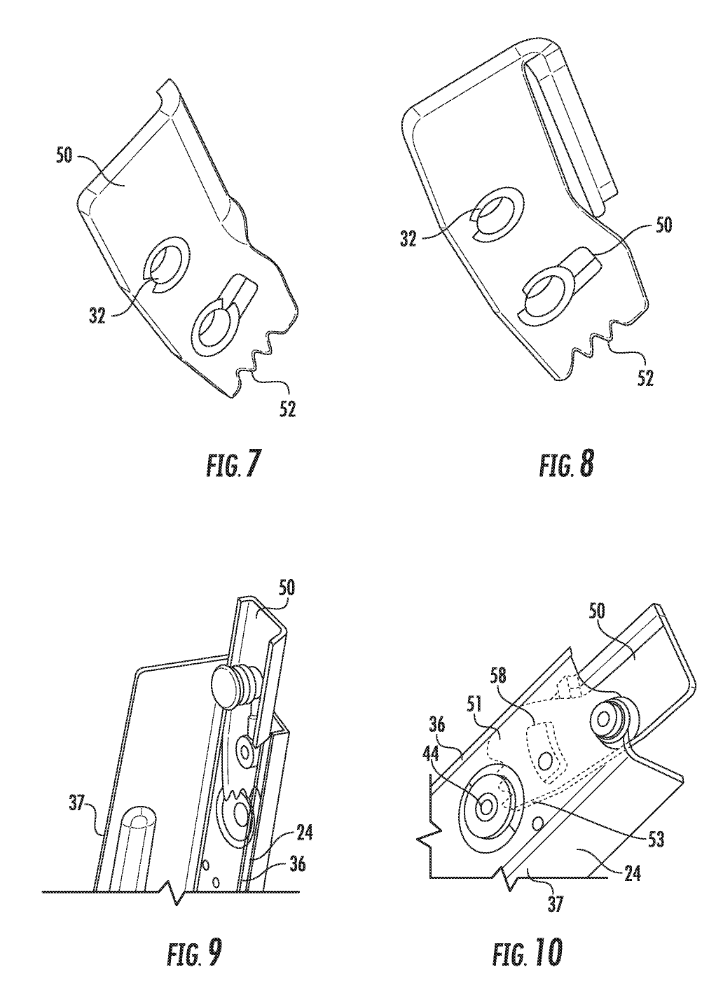

FIGS. 7 and 8 show the outboard and inboard gear sectors 50 in a subassembly stage with Norton bushings and prior to the full formation of the slot 58. FIGS. 7 and 8 show a stage prior to a full formation of the slots 58 (see also FIGS. 9 and 10) which, after completion will receive slot follower pins 54. The outboard and inboard gear sectors 50 are essentially mirror images of each other.

FIG. 9 shows the gear sector 50 in relation to the lower side frame member 24 (outboard site) with many of the other components of the pivot drive arrangement 40 removed. FIG. 10 again shows the outboard side, showing the gear sector 50 in relation to the lower side frame member 24 but viewing the lower portion (below the pivot 30) of the gear sector 50 through the lower side frame member 24. As can be seen in FIG. 10, the gear sector 50 includes a slot 58. A slot follower pin 54 has a shaft or post within the slot 58 (FIG. 6). The edge end walls of slot 58 define stops to define the full forward position F and the full rearward position R (FIGS. 1 and 2).

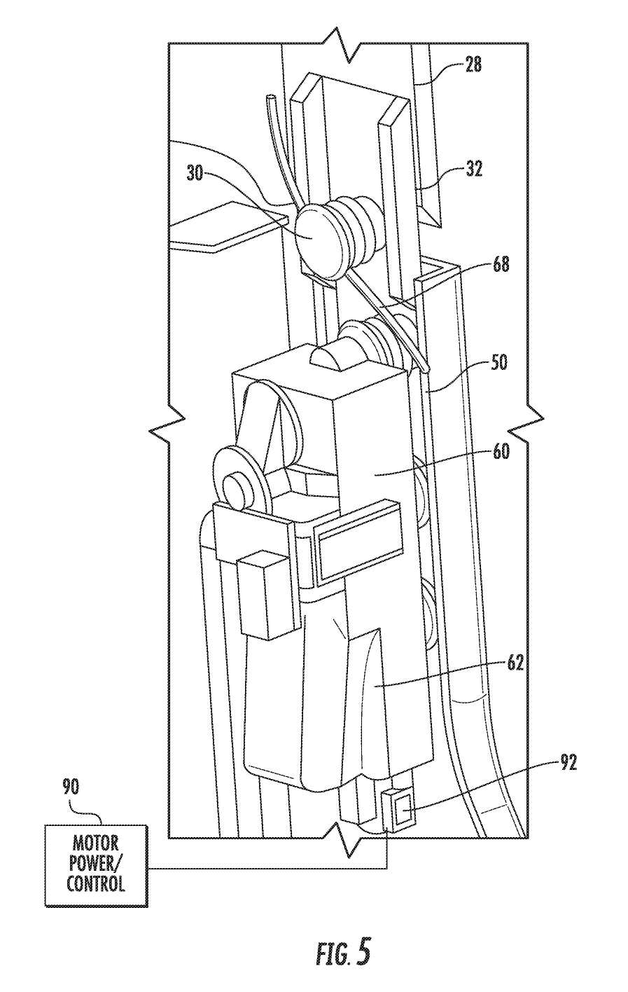

Depending upon the direction of rotation of the motor 62, the output shaft 64 drives the pinion gear 46, causing rotation of the gear sector 50 about the pivot 30. This causes the upper seat back portion 26 to move toward the forward direction or rearward direction between the forward stop and rear words stop defined by the slot 58 and the slot follower pin 54. A tension spring 68 is applied (FIG. 5) to stabilizing forces between the upper seat back portion 26 and the lower seat back portion 24, to remove slack and to provides smooth movement between the two portions.

Each motor assembly 60 has a power and control connection 92, connected to a power and control unit 90. The power and control connection 92 is shown connected to the power and control unit 90 schematically in FIG. 5.

Each motor assembly 60 has a width dimension that allows it to be placed between forward edge flange 36 and rear edge flange (or bead/bend) 37 of each of the lower frame members. In particular, the forward edge flange 36 and the rear edge flange 37 determine a maximum frame mounting dimension D (FIG. 2), within which the motor assembly 60 is provided. Advantageously each motor assembly 60 is an s-type actuator, which may have a width dimension less than 35 mm. The power shoulder pivot drive arrangement 40 (the power shoulder pivot package) can be about 35 mm wide (including the pivot range of the lower portion 52—tooth portion—of the gear sector 50). The arrangement allows the sector gear teeth 52 to move relative to the pinion gear 46 such that lateral edges 51 and 53 are within a region between the forward edge flange 36 and rear edge flange 37—over a full range of movement of the upper seat back portion 26, between the full forward pivot position F and the full rearward pivot position R.

While specific embodiments of the invention have been shown and described in detail to illustrate the application of the principles of the invention, it will be understood that the invention may be embodied otherwise without departing from such principles.

### LIST OF REFERENCE SYMBOLS

10 vehicle seat
12 headrest
16 seat base
18 seat pivot fitting
20 seat back
22 lower seat back portion
21 lower cross member
24 lower side frame member
25 middle cross member
26 upper seat back portion
27 upper cross member
28 upper side frame member
30 pivot connection
32 upper region pivot support
34 lower region pivot support
36 forward edge flange
37 rearward edge flange
40 power shoulder pivot drive arrangement
42 support bracket
44 pinion gear bearing
46 pinion gear
48 pinion gear teeth
50 gear sector
51 sector lateral edge
52 sector gear teeth
53 sector lateral edge
54 slot follower pin
58 slot
60 motor assembly
62 motor
64 output (drive) shaft
68 tension spring
90 power and control unit
92 power and control connection
D frame mounting space
F full forward pivot position
R full rearward pivot position

1. A vehicle seat back comprising:
a lower seat back portion comprising a lower inboard side frame member defining a pivot support at an upper region and a lower outboard side frame member defining a pivot support at an upper region;
an upper seat back portion comprising an upper inboard side frame member with a pivot support and with an associated inboard gear sector comprising a lower edge with inboard sector gear teeth and a lower outboard side frame member with a pivot support and with an associated gear sector comprising a lower edge with outboard sector gear teeth;
an inboard pivot connection pivotally connecting the lower inboard side frame member to the upper inboard side frame member at the pivot supports;
an outboard pivot connection pivotally connecting the lower outboard side frame member to the upper outboard side frame member at the pivot supports;
an inboard pinion gear with gear teeth engaged with the inboard sector gear teeth, the inboard pinion gear being connected to the lower inboard side frame member for rotation in each of two rotational directions;
an outboard pinion gear with gear teeth engaged with the outboard sector gear teeth, the outboard pinion gear being connected to the lower outboard side frame member for rotation in each of two rotational directions;
an inboard motor assembly mounted to the lower inboard side frame member and comprising a motor and an output shaft connected to the inboard pinion gear for driving the inboard pinion gear in each of the two rotational directions; and
an outboard motor assembly mounted to the lower outboard side frame member and comprising a motor and an output shaft connected to the outboard pinion gear for driving the outboard pinion gear in each of the two rotational directions, whereby operation of the motors in one direction, pivots the upper seat back relative to the lower seat back in a forward pivot direction and operation of the motors in another direction pivots the seat back relative to the lower seat back in a rearward direction.

2. A vehicle seat back according to claim 1, further comprising a head restraint connected to the upper seat back portion for movement with the upper seat back portion.

3. A vehicle seat back according to claim 1, wherein:
each of the lower side frame members has edges defining a motor assembly mounting region, wherein the motor assembly mounting region has a dimension between lower side frame member edges of about 35 mm or more; and
the motor assembly has a width dimension of about 35 mm and is positioned between the edges of the lower side frame members.

4. A vehicle seat back according to claim 1, wherein:
each gear sector has a slot defining a forward and a rearward stop;
each lower side frame member has a slot follower pin that passes through the slot and allows rotation of the respective gear sector corresponding to a movement of the slot relative to the slot follower pin between the forward and the rearward stop.

5. A vehicle seat back according to claim 1, further comprising a power and control unit for powering each motor and controlling the rotational speed in rotational direction of each motor.

6. A vehicle seat back according to claim 1, wherein the gear sector is formed as a sector part that is separate from the associated side upper frame member and is subsequently fixed to the associated side frame member.

7. A vehicle seat back according to claim 1, wherein the gear sector is formed as a sector that is integral with the associated side upper frame members.

8. A vehicle seat comprising:
a seat base; and
a vehicle seat back connected to the seat base, the seat back comprising:
a lower seat back portion comprising a lower inboard side frame member defining a pivot support at an upper region and a lower outboard side frame member defining a pivot support at an upper region;
an upper seat back portion comprising an upper inboard side frame member with a pivot support and with an associated inboard gear sector comprising a lower edge with inboard sector gear teeth and a lower outboard side frame member with a pivot support and with an associated gear sector comprising a lower edge with outboard sector gear teeth;
an inboard pivot connection pivotally connecting the lower inboard side frame member to the upper inboard side frame member at the pivot supports;
an outboard pivot connection pivotally connecting the lower outboard side frame member to the upper outboard side frame member at the pivot supports;
an inboard pinion gear with gear teeth engaged with the inboard sector gear teeth, the inboard pinion gear being connected to the lower inboard side frame member for rotation in each of two rotational directions;
an outboard pinion gear with gear teeth engaged with the outboard sector gear teeth, the outboard pinion gear being connected to the lower outboard side frame member for rotation in each of two rotational directions;
an inboard motor assembly mounted to the lower inboard side frame member and comprising a motor and an output shaft connected to the inboard pinion gear for driving the inboard pinion gear in each of the two rotational directions; and
an outboard motor assembly mounted to the lower outboard side frame member and comprising a motor and an output shaft connected to the outboard pinion gear for driving the outboard pinion gear in each of the two rotational directions, whereby operation of the motors in one direction, pivots the upper seat back relative to the lower seat back in a forward pivot direction and operation of the motors in another direction pivots the seat back relative to the lower seat back in a rearward direction.

9. A vehicle seat according to claim 8, further comprising a pivot fitting connecting the seat base to the vehicle seat back for pivoting movement of the vehicle seat back relative to the seat base.

10. A method of forming a vehicle seat back, the method comprising the steps of:
forming a lower seat back portion comprising a first side lower frame member and second side lower frame member;
forming an upper seat back portion comprising a first side upper frame member and second side upper frame member, each side upper frame member comprising a gear sector comprising a lower edge with sector gear teeth;
connecting the upper seat back portion to the lower seat back portion with pivot connections pivotally connecting the lower side frame members to the upper side frame members; and
providing pivot drive arrangements at each first side lower frame member and second side lower frame member, each drive arrangement comprising:
a pinion gear with gear teeth engaged with the associated sector gear teeth; and
a motor assembly mounted to the associated lower side frame member, the motor assembly comprising a motor and an output shaft driving the pinion gear in each of two rotational directions, wherein rotation of the motor in one direction, pivots the upper seat back relative to the lower seat back in a forward pivot direction and rotation of the motors in an opposite direction pivots the seat back relative to the lower seat back in a rearward direction.

11. A method according to claim 10, wherein the gear sector is formed as a sector part that is separate from the associated side upper frame member and is subsequently fixed to the associated side frame member.

12. A method according to claim 10, wherein the gear sector is formed as a sector that is integral with the associated side upper frame members.

13. A method according to claim 10, further comprising connecting a head restraint to the upper seat back portion for movement with the upper seat back portion.

14. A method according to claim 10, wherein:
at least one of the lower side frame members has a forward and a rearward end that defines a drive arrangement operation area;
the gear sector is dimensioned and the gear teeth of the gear sector and pinion gears are provided such that a lower portion of the gear sector moves in a pivoting range between the frame members forward and rearward ends.

15. A method according to claim 10, wherein:
at least one of the gear sectors has a slot defining a forward and a rearward stop;
at least one of the lower side frame members has a slot follower pin that passes through the slot and allows a pivoting of the gear sector corresponding to a movement of the slot relative to the slot follower pin between the forward and the rearward stop.

16. A vehicle seat according to claim 8, wherein the seat back further comprises a head restraint connected to the upper seat back portion for movement with the upper seat back portion.

17. A vehicle seat according to claim 8, wherein:
each of the lower side frame members has edges defining a motor assembly mounting region, wherein the motor assembly mounting region has a dimension between lower side frame member edges of about 35 mm or more; and
the motor assembly has a width dimension of about 35 mm and is positioned between the edges of the lower side frame members.

18. A vehicle seat according to claim 8, wherein:
each gear sector has a slot defining a forward and a rearward stop;
each lower side frame member has a slot follower pin that passes through the slot and allows rotation of the respective gear sector corresponding to a movement of the slot relative to the slot follower pin between the forward and the rearward stop.

19. A vehicle seat according to claim 8, further comprising a power and control unit for powering each motor and controlling the rotational speed in rotational direction of each motor.

20. A vehicle seat according to claim 8, wherein the gear sector is formed as a sector part that is separate from the associated side upper frame member and is subsequently fixed to the associated side frame member or the gear sector is formed as a sector that is integral with the associated side upper frame members.
